(19) United States
(12) Patent Application Publication
(10) Pub. No.: US 2012/0044174 A1
(43) Pub. Date: Feb. 23, 2012

(54) METHOD AND APPARATUS FOR TOUCH INPUT IN PORTABLE COMMUNICATION SYSTEM

(75) Inventor: Ki-Yeung KIM, Gyeonggi-do (KR)

(73) Assignee: SAMSUNG ELECTRONICS CO., LTD., Gyeonggi-Do (KR)

(21) Appl. No.: 13/198,792

(22) Filed: Aug. 5, 2011

(30) Foreign Application Priority Data
Aug. 20, 2010 (KR) 10-2010-0080742

(51) Int. Cl. G06F 3/041

(52) U.S. Cl. 345/173

(57) ABSTRACT

An apparatus and method for providing a touch input in a portable terminal are provided. In particular, an apparatus and method capable of determining through tactile sense a plurality of input buttons included in a virtual input window, which is displayed on a touch screen of the portable terminal are provided. The apparatus includes a pattern apply unit for applying a pattern used to determine an activation of an input button, the pattern being provided on a layer having a plurality of tactile materials during a touch input mode. When a power is supplied, an arrangement position of the tactile materials is changed according to the applied pattern, and a controller for controlling the pattern apply unit to determine the input button, position, or location of the input button through tactile sense.

### CLAIM OF PRIORITY

This application claims the benefit of under 35 U.S.C. §119(a) from a Korean patent application filed in the Korean Intellectual Property Office on Aug. 20, 2010 and assigned Serial No. 10-2010-0080742, the entire disclosure of which is hereby incorporated by reference.

### BACKGROUND OF THE INVENTION

1. Field of the Invention

The present invention relates to an apparatus and method for providing a touch input in a portable terminal. More particularly, the present invention relates to an apparatus and method capable of determining through tactile sense a plurality of input buttons provided in a virtual input window of a touch screen of the portable terminal.

2. Description of the Related Art

The demand for portable terminals is growing exponentially, and service providers (or terminal manufacturers) are competitively developing more convenient functions to attract more users.

Currently, the portable terminal provides various functions such as a phonebook, a game, a scheduler, a Short Messaging Service (SMS), a Multimedia Message Service (MMS), a Broadcast Message Service (BMS), an Internet service, an Electronic (e)-mail service, a wake-up call, Motion Picture Expert Group (MPEG)-1 or MPEG-2 Audio Layer-3 (MP3) players, a digital cameras, and other similar products and services.

In addition, with the development of a touch screen-type portable terminal for inputting data via a user's finger or a stylus pen, a user can easily enter a text or draw a line on the portable terminal.

The touch screen type can be classified into a resistive type and a capacitive type. The resistive type is a method in which an upper plate electrode and a lower plate electrode are arranged so that when the user presses an upper plate causing it to contact with a lower plate, a coordinate is read by using a resistance value. The capacitive type is a method in which a capacitance of a human body is used to find a coordinate when a touch is made by using the capacitance that varies when a screen is touched.

The resistive type does not allow multiple touches, but enables a delicate touch input. The capacitive type does not allow the use of an additional input tool such as a stylus pen, but is advantageous for an icon-oriented touch input.

When using the touch screen type, a user has to touch a corresponding input button while visually determining a virtual input window (i.e., a character input window, a qwerty keypad, etc.) displayed on a flat screen panel.

Meanwhile, a user of a portable terminal having a keypad knows a position of an input button through frequent operation, and thus is able to input a character without the use of visual sense. That is, the keypad has a slot between buttons to physically recognize tactile sense of the user so that the user can determine a button position. However, since an input window displayed on a touch screen is used for input in the touch screen type, there is a problem in that a position of the input button cannot be determined through user's tactile sense as in the key pad.

Accordingly, there is a need for an apparatus and method capable of determining an input button provided in an input window that is displayed on a touch screen through tactile sense in a portable terminal.

### SUMMARY OF THE INVENTION

An exemplary aspect of the present invention is to provide an apparatus and method for a touch screen capable of determining an input button in a portable terminal.

Another exemplary aspect of the present invention is to provide an apparatus and method for determining an input button by applying a pattern to a virtual input window in a portable terminal.

Another exemplary aspect of the present invention is to provide an apparatus and method for determining an input button by arranging a tactile material to a position around a pattern applied to a virtual input window in a portable terminal.

Another exemplary aspect of the present invention is to provide an apparatus and method for a touch input including a pattern to which power can be supplied so that a tactile material attracted towards a pattern to which power is supplied can be moved a position around the pattern for distinction of input buttons.

In accordance with an aspect of the present invention, an apparatus for providing a touch input of a portable terminal includes: a pattern apply unit for applying a pattern to a layer including a plurality of tactile materials during a touch input mode and for changing an arrangement position of the tactile materials according to the applied pattern, and a controller for controlling the pattern apply unit to determine an activation of the input button through tactile sense or the boundary or position of each input buttons through tactile sense generated by the applied pattern.

In accordance with another aspect of the present invention, a method for providing a touch input in a portable terminal includes applying a pattern capable of determining an input button to a layer including a plurality of tactile materials during in a touch input mode, and changing an arrangement position of the tactile materials according to the applied pattern.

In accordance with another aspect of the present invention, a touch screen of a portable terminal includes a touch screen panel for detecting a user's touch input, a layer coated on the touch screen panel and including a plurality of tactile materials, an input mode determination unit for determining a character input mode operated by a user, a pattern apply unit for applying a pattern capable of changing arrangement of the tactile material to the layer according to the determined input mode, and a power supply unit for changing arrangement of the tactile material of the layer by supplying power to the layer, wherein the tactile material is movable by electric current.

### BRIEF DESCRIPTION OF THE DRAWINGS

The above and other exemplary aspects, features and advantages of certain exemplary embodiments of the present invention will be more apparent to a person of ordinary skill in the art from the following detailed description taken in conjunction with the accompanying drawings, in which:

FIG. 1 is a block diagram of a portable terminal according to an exemplary embodiment of the present invention;

FIG. 2 is a flowchart illustrating a touch input process of a portable terminal according to an exemplary embodiment of the present invention;

FIG. 3 is a flowchart illustrating a process for determining an input button according to a pattern displayed on a touch screen of a portable terminal according to an exemplary embodiment of the present invention;

FIG. 4A illustrates an input device of a portable terminal according to an exemplary embodiment of the present invention;

FIG. 4B illustrates a structure of a layer including a tactile material according to an exemplary embodiment of the present invention;

FIG. 4C illustrates tactile material arrangement of a layer including a tactile material according to an exemplary embodiment of the present invention;

FIG. 5A illustrates a screen before applying a pattern to a dial input window according to another exemplary embodiment of the present invention;

FIG. 5B illustrates a screen in which a pattern is applied to a dial input window according to another exemplary embodiment of the present invention;

FIG. 5C is a lateral view of a pattern applied to a dial input window according to another exemplary embodiment of the present invention;

FIG. 6A illustrates a screen before applying a Korean-alphabet input window according to another exemplary embodiment of the present invention; and

FIG. 6B illustrates a process of applying a pattern to a Korean-alphabet input window according to an exemplary embodiment of the present invention.

FIGS. 7A through 7G are examples of pattern for numbers and characters according to another embodiment of the present invention.

### DETAILED DESCRIPTION

Exemplary embodiments of the present invention will be described herein below with reference to the accompanying drawings. For the purposes of clarity and simplicity, well-known functions or constructions are not described in detail as they would obscure the invention in unnecessary detail.

The present invention described below relates to an apparatus and method for determining an input button by arranging a tactile material to a position around a pattern applied to a virtual input window so that a user can easily determine a displayed input button through tactile sense in a portable terminal.

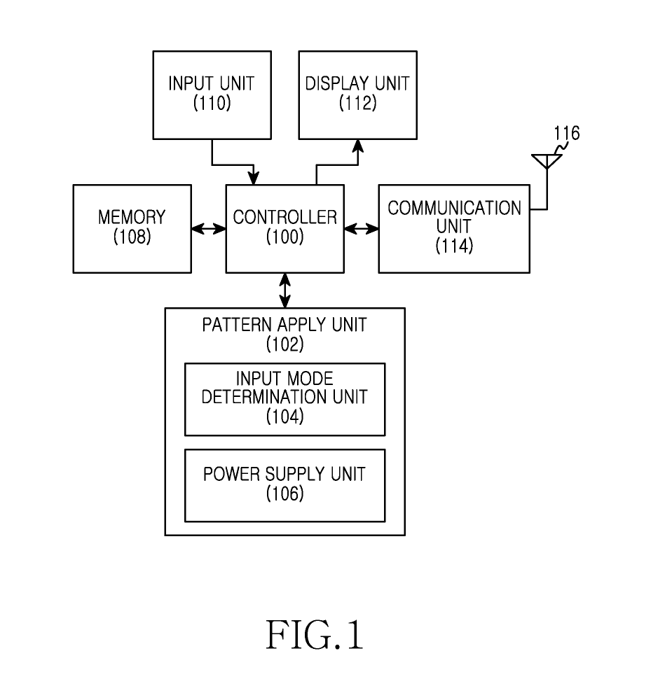

FIG. 1 is a block diagram of a portable terminal for determining an input button displayed on a touch screen through tactile sense according to an exemplary embodiment of the present invention.

Referring to FIG. 1, the portable terminal includes a controller 100, a pattern apply unit 102, a memory 108, an input unit 110, a display unit 112, and a communication unit 114. The pattern apply unit 102 includes an input mode determination unit 104 and a power supply unit 106. The portable communication terminal may include additional units that are not illustrated here for sake of clarity. Similarly, the functionality of two or more of the above units may be integrated into a single component.

The controller 100 provides overall control to the portable terminal. For example, the controller 100 processes and controls voice communication and data communication. In addition to its conventional function, the controller 100 according to the present invention further allows a user to able to feel and determining the displayed input button (i.e., a position of the input button, an interval between the input buttons, data allocated to the input button, etc.) on a touch screen through tactile sense.

That is, the controller 100 applies a pattern capable of determining the input button to the touch screen. This is achieved by providing a layer coated on the touch screen where the tactile materials in the layer is arranged according to the pattern for distinction of the displayed input buttons. Thus, the user can determine the input button through tactile sense with respect to the tactile material arranged on the pattern.

Under the control of the controller 100, the pattern apply unit 102 arranges the tactile material to a position around the input button displayed on the touch screen so that the input button is determined through user's tactile sense. The tactile material is arranged in a different position according to electric current that flows through the pattern as power is supplied thereto. The tactile material included, for example, organic electro luminescence material and piezo electric material.

The pattern apply unit 102 can arrange the tactile material in the same shape as a desired pattern by supplying power according to the pattern. Herein, all materials which are movable by electric current that flows through the pattern when power is supplied thus defining the tactile materials in the desired pattern.

The pattern apply unit 102 includes a tactile material that can be arranged to a position around or according to the pattern, which is used to determine the input button or the boundary or positions of the input buttons.

Under the control of the pattern apply unit 102, the input mode determination unit 104 of the pattern apply unit 102 determines an input mode of the touch screen currently operated by the user among input modes of the touch screen, i.e., any one of a dial input screen, a Korean-alphabet input screen, an English-alphabet input screen, a qwerty keypad, etc.

Under the control of the pattern apply unit 102, the power supply unit 106 of the pattern apply unit 102 supplies power to the pattern (i.e., a pattern having a shape for determining the input button such as an English-alphabet shape, a Korean-alphabet shape, a braille shape, an interval separation shape, etc.) applied to the pattern apply unit 102 (i.e., an additional layer including the tactile material), so that the tactile material arranged to a position around the pattern has the same shape, thus defining the input button or the boundary of the input buttons.

The memory 108 preferably include non-transitory machine readable medium(s), such as Read Only Memory (ROM), Random Access Memory (RAM), a flash ROM, or other similar storage devices. The ROM stores a microcode of a program, by which the controller 100 and the pattern apply unit 102 are processed and controlled, and a variety of reference data.

The RAM is a working memory of the controller 100 and stores temporary data that is generated while programs are performed. The flash ROM stores a variety of rewritable data, such as phonebook entries, outgoing messages, and incoming messages.

The input unit 110 preferably includes a plurality of function keys such as numeral key buttons of ‘0’ to ‘9’, a menu button, a cancel button, a confirm button, a talk button, an end button, an Internet access button, a navigation key button, and a character input key. Key input data (e.g., a character input request), which is input when the user presses these keys, is provided to the controller 100. The input unit 110 can be joined to the display unit 112 to analyze the user's touch input and to provide the analyzed touch input to the controller 100.

The display unit 112 preferably displays information such as state information, which is generated while the portable terminal operates, a limited number of characters, a large volume of moving and still pictures, etc. The display unit 112 may be a color Liquid Crystal Display (LCD), an Active Mode Organic Light Emitting Diode (AMOLED) display, and/or other types of thin-film technology screen display apparatuses. According to the present invention, the display unit 112 is configured with a touch screen and displays a virtual input window so as to receive a touch input of the user.

The communication unit 114 transmits and receives a Radio Frequency (RF) signal of data that is input and output through an antenna (116). For example, in a transmitting process, data to be transmitted is subject to a channel-coding process and a spreading process, and then the data is transformed to an RF signal. In a receiving process, the RF signal is received and transformed to a base-band signal, and the base-band signal is subject to a de-spreading process and a channel-decoding process, thereby restoring the data.

The communication unit 114 could also include a communication port for wired transfer, such as USB, and may also communicate in short-range protocols such as Bluetooth, etc. For example, time division and frequency division are just a few examples of possible protocols. It is also to be appreciated by a person of ordinary skill in the art that the communication protocol is in no way limited to spread spectrum techniques.

Although a function of the pattern apply unit 102 can be performed by the controller 100 of the portable terminal, the pattern apply unit 102 and the controller 100 are separately constructed in the present invention for exemplary purposes only. Thus, those ordinary skilled in the art can understand that various modifications can be made within the scope of the present invention. For example, functions of the pattern apply unit 102 and the controller 100 can be integrally configured to be processed by the controller 100.

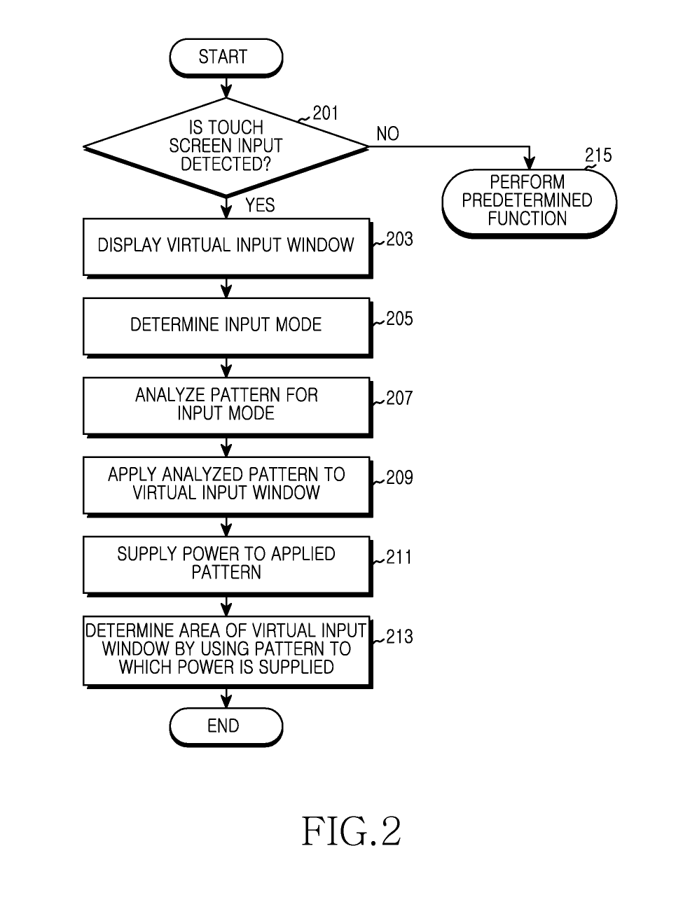

FIG. 2 is a flowchart illustrating a touch input process of a portable terminal according to an exemplary embodiment of the present invention.

Referring to FIG. 2, the portable terminal detects a touch screen input in step 201. Herein, the touch screen input implies a user's touch input, such as a touch input for inputting characters, a touch input for selecting a menu, etc.

If the touch screen input is not detected in step 201, processing to step 215, the portable terminal performs a predetermined function (e.g., a standby mode).

If the touch screen input is detected in step 201, proceeding to step 203, the portable terminal displays a virtual input window on a display unit (i.e., a touch screen). Herein, the virtual input window implies a dial input screen, a Korean-alphabet input screen, an English-alphabet input screen, a qwerty keypad, or the like that can be displayed on the touch screen for the touch input process of the user.

In general, the virtual input window is used to select data of a specific region by detecting a touch input on the display region (i.e., an input button). When input buttons are selected, they are surrounded by a box or a shadow, and thus each input button can be determined visually only.

That is, the user of the portable terminal cannot determine an interval between input buttons through tactile sense with respect to a surface of the virtual input window. A keypad included in a general slide-type portable terminal has a slot between buttons to physically recognize tactile sense of the user so that the user can determine a button position through tactile sense. However, the aforementioned touch screen type portable terminal has to determine the input button through visual sense.

In order to solve the aforementioned problem, the present invention uses the following process to determine an area, position, and shape of input buttons included in the virtual input window displayed on the touch screen.

That is, in step 205, the portable terminal determines an input mode of the touch screen. Herein, the input mode of the touch screen can be any one of a dial input screen, a Korean-alphabet input screen, an English-alphabet input screen, a qwerty keypad, or the like which can determine an input mode currently operated by the user.

In step 207, the portable terminal analyzes a pattern for the determined input mode. In step 209, the portable terminal applies the analyzed pattern to the virtual input window. Herein, the pattern is a pattern capable of determining an input button through tactile sense of the user of the portable terminal, and is a pattern corresponding to an input mode, such as a numeral character pattern, an area pattern, a Korean-alphabet pattern, and an English-alphabet pattern.

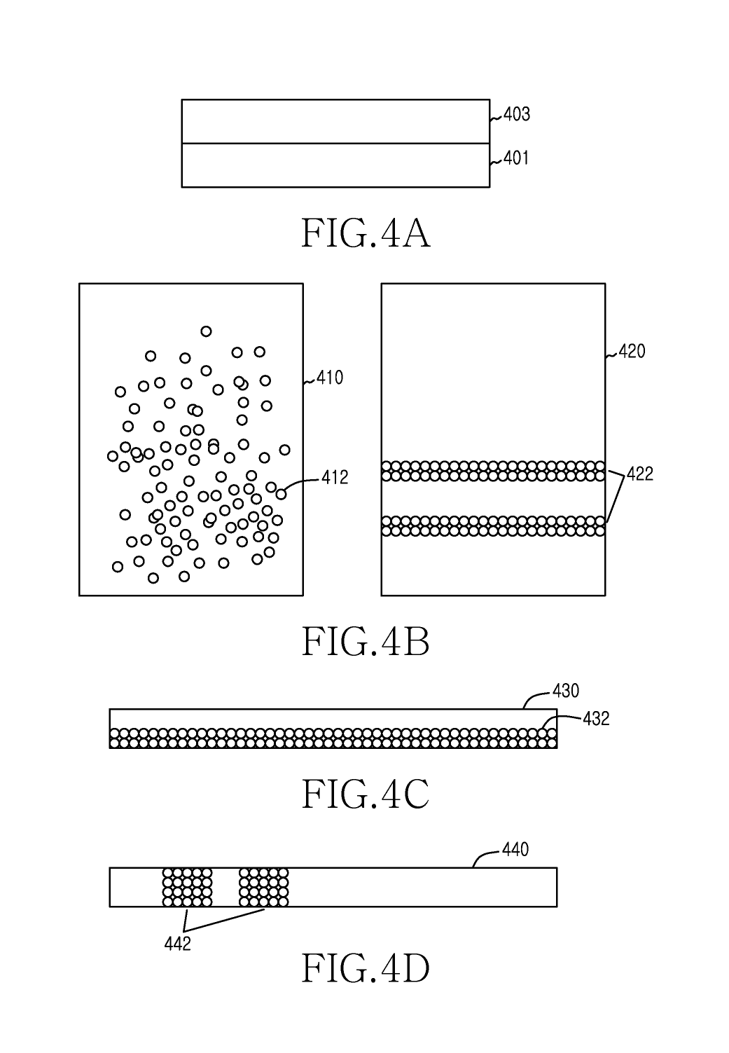

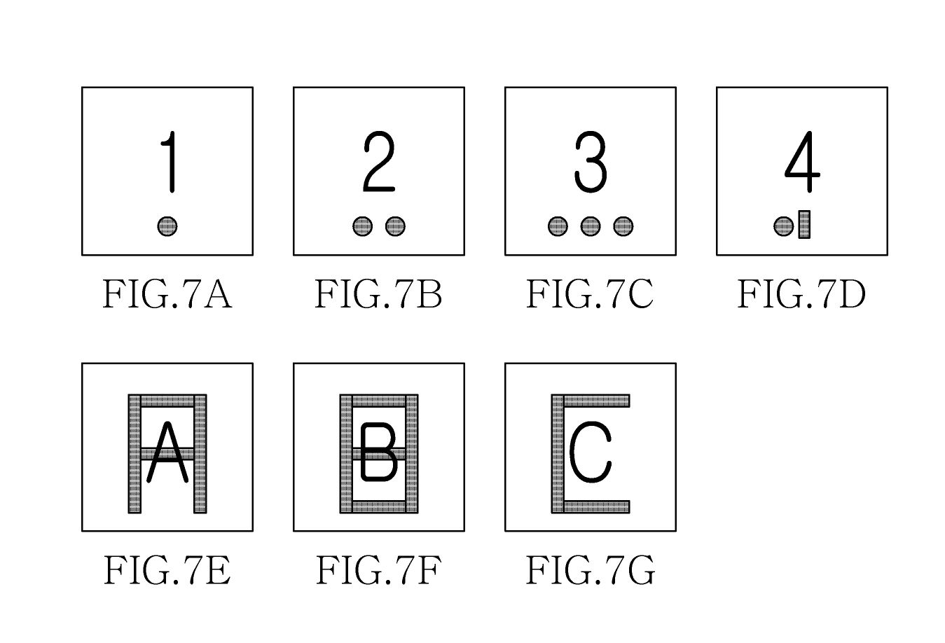

The numeral character pattern is a pattern for arranging a tactile material in a numeral character shape on a flat dial input screen on the touch screen in order to detect tactile sense in the numeral character shape. The area pattern is a pattern for arranging the tactile material in a shape of determining an area in order to determine neighboring input buttons. The Korean-alphabet pattern is a pattern for determining a Korean-alphabet corresponding to an input button by using the tactile material. Similarly to the Korean-alphabet pattern, the English character pattern is a pattern for determining an English-alphabet corresponding to an input button by using the tactile material. All materials which are movable by electric current that flows through the pattern when power is supplied are collectively defined as the tactile material. Specifically, FIGS. 7A through 7G are examples of pattern for numbers and characters. Also the following descriptions in connection with FIGS. 4, 5, and 6 are illustrating the embodiment of the present invention.

In step 211, the portable terminal supplies power to the pattern applied in step 209. In step 213, the portable terminal allows an area of the virtual input window (i.e., input buttons) to be determined by using the pattern to which power is supplied.

Herein, the tactile materials are uniformly distributed to a layer independent from the touch screen to maintain a flat state, and when power is supplied to the pattern, the tactile materials are arranged to a position around the pattern to which power is supplied so that tactile sense corresponding to the pattern is delivered to the user. That is, the tactile materials are arranged to a position around the pattern similarly to an iron power that gathers around an electromagnet.

Thereafter, the procedure of FIG. 2 ends.

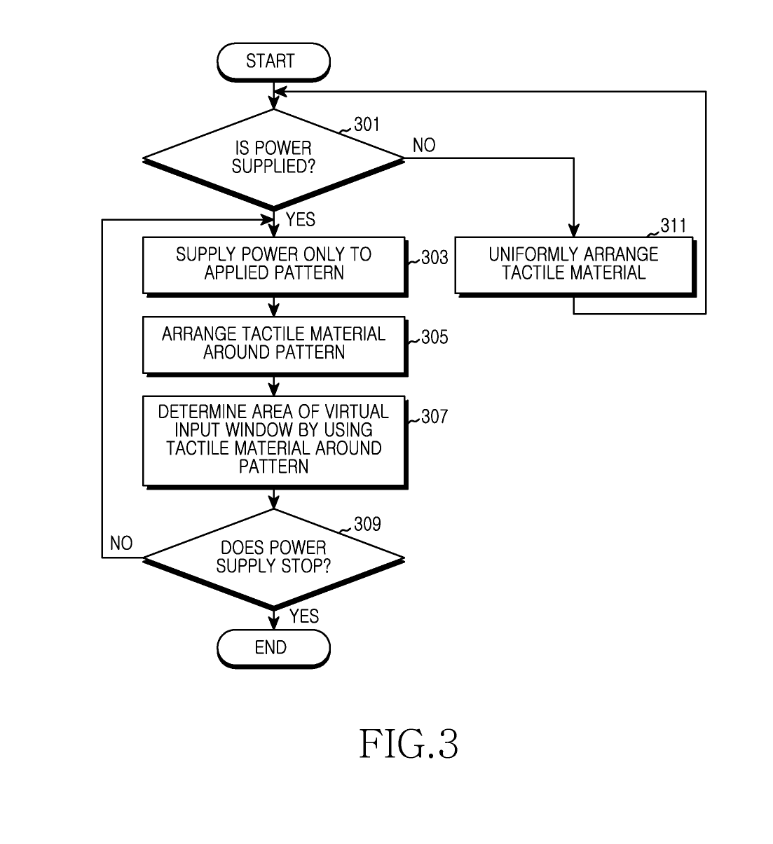

FIG. 3 is a flowchart illustrating a process for determining an input button according to a pattern displayed on a touch screen of a portable terminal according to an exemplary embodiment of the present invention.

Referring to FIG. 3, the portable terminal determines whether power is supplied to a pattern that can be used to determine the input button through tactile sense in step 301.

If it is determined in step 301 that power is not supplied to the pattern, proceeding to step 311, the portable terminal uniformly arranges the tactile material, and then step 301 is repeated. Herein, the tactile material moves to a position around the pattern only when power is supplied to the pattern. Thus, in step 311, the tactile material does not move and maintains uniform arrangement.

If it is determined in step 301 that power is supplied to the pattern, proceeding to step 303, the portable terminal supplies power only to the pattern applied in step 209 of FIG. 2. In step 305, the portable terminal arranges the tactile material to a position around the applied pattern. That is, tactile materials uniformly arranged before power is supplied start to move to a position around the pattern to which power is supplied.

In step 307, the portable terminal allows an area of a virtual input window to be determined by using a tactile material around the pattern. In step 309, the portable terminal determines whether the supply of power to the pattern stops.

If it is determined in step 309 that the supply of power supply does not stop, step 303 is repeated.

Otherwise, if it is determined in step 309 that the supply of power stops, the procedure of FIG. 3 ends.

FIG. 4 illustrates a structure of an apparatus for a touch input of a portable terminal according to an exemplary embodiment of the present invention.

FIG. 4A illustrates an input device of a portable terminal capable of determining an input button according to an exemplary embodiment of the present invention.

Referring now to FIG. 4A, the input device can be formed in a two-layer format, i.e., a touch screen layer 401 coated with a layer 403 including a tactile material.

The touch screen layer 401 implies a touch screen panel for detecting a user's touch input. The layer 403 including the tactile material is a layer for providing tactile sense based on a shape of an input button to a user. A pattern for determining the input button is applicable, and power is supplied to the applied pattern. When power is supplied to the pattern, the tactile material is arranged by electric current that flows through the pattern while maintaining a shape corresponding to a pattern shape. Therefore, the user can determine the pattern corresponding to the input button through tactile sense by touching the tactile material in the button shape with a particular character or symbols commonly found in a conventional key pad.

Herein, all materials which are movable by electric current that flows through the pattern when power is supplied define the virtual key pad, so that a user can determine a specific input button via the tactile material formed and defined in the button shape.

FIG. 4B illustrates a structure of a layer including a tactile material according to an exemplary embodiment of the present invention.

Referring to FIG. 4B, a layer 410 is a layer which is in a state where power is not supplied to a pattern, that is, a layer including a tactile material. A layer 420 is a layer which is in a state where power is supplied to the pattern.

The layer 410 includes a plurality of tactile materials 412. The tactile materials 412 are arranged differently according to the supply of power to the pattern.

For example, if a pattern having a shape of two lines is applied to the layer 420 including the tactile material and that power is applied to the pattern, then the tactile materials 412 included in the layer 420 are arranged in the pattern as indicated by a reference numeral 422.

FIG. 4C illustrates tactile material arrangement of a layer including a tactile material according to an exemplary embodiment of the present invention.

Referring now to FIG. 4C, a layer 430 including a tactile material is the layer of FIG. 4B, viewed from a lateral side. A plurality of tactile materials is uniformly arranged to the layer (as indicated by a reference numeral 432). This arrangement provides a flat surface of a touch screen.

If power is supplied to the layer, the tactile materials are arranged as the pattern applied to a layer 440 of FIG. 4D and thus are arranged in the shape as that indicated by a reference numeral 442 of FIG. 4D. When the tactile material is arranged in the shape described above, the touch screen provides the same effect as a shape of protruding two lines.

That is, as illustrated in FIG. 4, a circular-shaped tactile material is arranged in a plurality of layers around the pattern and is not arranged in other parts. Therefore, a user can feel through tactile sense only a position where the tactile material is arranged.

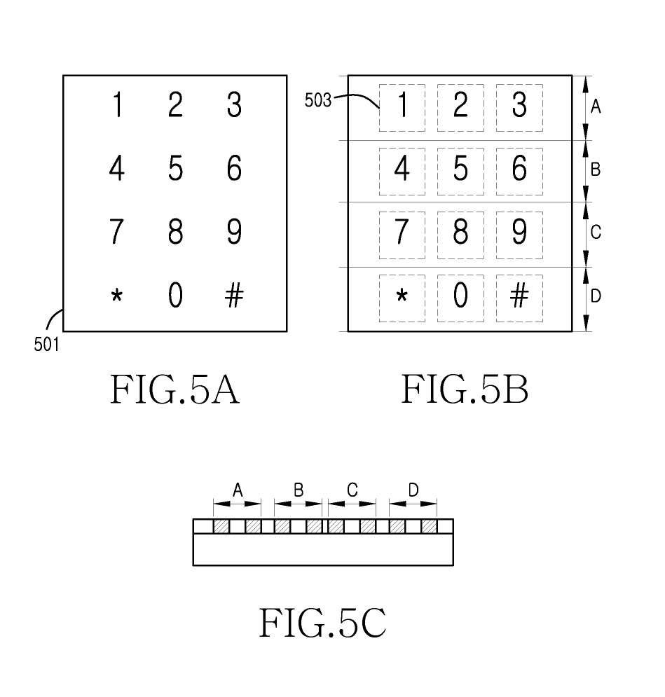

FIG. 5 illustrates a process of applying a pattern to a dial input window in a portable terminal according to another exemplary embodiment of the present invention.

FIG. 5A illustrates a screen before applying a pattern to a dial input window in a portable terminal according to another exemplary embodiment of the present invention.

Referring to FIG. 5A, the portable terminal displays the dial input window on a touch screen (as indicated by a reference numeral 501). Each of dials of the dial input window has to be determined through user's visual sense. That is, the dials cannot be determined through tactile sense, and thus if a dial “1” is input, the user has to input the dial after determining the dial directly through the user's visual sense.

FIG. 5B illustrates a screen in which a pattern is applied to a dial input window in a portable terminal according to another exemplary embodiment of the present invention.

Referring now to FIG. 5B, the portable terminal applies the pattern to each of dial input windows in order to determine dials through tactile sense.

That is, the portable terminal applies a pattern having a box shape as illustrated in the figure to arrange a tactile material to a position around a dial (as indicated by a reference numeral 503), so that a user of the portable terminal can determine a position of each dial through tactile sense. Although a pattern corresponding to a border of the dial is applied in the present invention, it is also possible to apply a pattern having a braille shape that represents data corresponding to the dial according to another exemplary embodiment of the present invention.

In addition, English-alphabets A, B, C, and D that represent horizontal lines are for determining tactile material arrangement viewed from the touch screen of the portable terminal, which will be described below in greater detail in FIG. 5C.

FIG. 5C is a lateral view of a pattern applied to a dial input window in a portable terminal according to another exemplary embodiment of the present invention.

Referring now to FIG. 5C, the portable terminal can determine a dial through tactile sense as described above when applying the pattern to the dial input window as illustrated in FIG. 5B.

The dials included in the horizontal lines of FIG. 5B can be determined depending on each horizontal line as illustrated in FIG. 5C. Since the pattern is applied in a vertical line in FIG. 5B, the dials can also be determined depending on each vertical line.

That is, a pattern corresponding to dials “1”, “2”, and “3” in association with a line A illustrated in FIG. 5B is applied to a line corresponding to the English-alphabet A. A pattern corresponding to dials “4”, “5”, and “6” in association with a line B illustrated in FIG. 5B is applied to the line corresponding to an English-alphabet B. A pattern corresponding to dials “7”, “8”, and “9” in association with a line C illustrated in FIG. 5B is applied to a line corresponding to the English-alphabet C. A pattern corresponding to dials “*”, “0”, and “#” in association with a line D illustrated in FIG. 5B is applied to a line corresponding to the English-alphabet D.

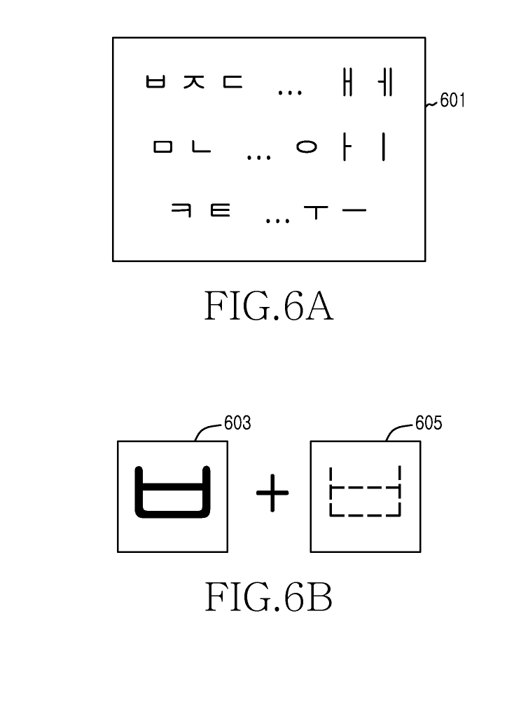

FIG. 6 illustrates a process of applying a Korean-alphabet input window in a portable terminal according to another exemplary embodiment of the present invention.

FIG. 6A illustrates a screen before applying a Korean-alphabet input window in a portable terminal according to another exemplary embodiment of the present invention.

Referring to FIG. 6A, the portable terminal displays a Korean-alphabet input window (as illustrated by a reference numeral 601) similarly to Korean-alphabet arrangement of a keyboard on a touch screen. Each of dials of the Korean-alphabet input window has to be determined through user's visual sense. That is, the dials cannot be determined through tactile sense, and thus if a dial corresponding to “ [symbol] ” is input, the user has to input the dial after determining the dial directly through user's visual sense.

FIG. 6B illustrates a process of applying a pattern to a Korean-alphabet input window in a portable terminal according to an exemplary embodiment of the present invention.

Referring now to FIG. 6B, the portable terminal applies the pattern to each Korean-alphabet input window in order to determine a dial through tactile sense.

For example, when the pattern is applied to an input button corresponding to a Korean-alphabet “ [symbol] ”, the pattern can be a pattern having a shape of the input button “ [symbol] ”. Power can be supplied to the pattern. When power is supplied to the pattern, tactile materials which are positioned around the pattern are attracted towards a position around the pattern having a shape of “ [symbol] ”, and thus the user can determine a Korean-alphabet allocated to a corresponding input button by using the tactile material attracted towards a position around the pattern having the shape of “ [symbol] ”.

An input button 603 corresponding to the Korean-alphabet “ [symbol] ” implies a touch screen panel. A pattern 605 having a shape of the input button “ [symbol] ” implies a layer including a tactile material coated on the touch screen panel.

FIGS. 7A through 7G are examples of pattern for numbers and characters according to another embodiment of the present invention. Patterns having braille shapes that represent number are displayed. Also, patterns for alphabets displayed.

According to exemplary embodiments of the present invention, tactile materials are arranged to a position around a pattern applied to a virtual input window so that an input button displayed on a touch screen with a flat surface can be determined through tactile sense.

The above-described methods according to the present invention can be implemented in hardware, firmware or as software or computer code that can be stored in a recording medium such as a CD ROM, an RAM, a floppy disk, a hard disk, or a magneto-optical disk or downloaded over a network and stored on a non-transitory machine readable medium, so that the methods described herein can be rendered in such software using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An apparatus for providing a touch input in a portable terminal, comprising:
a pattern apply unit for applying a predetermined pattern on a layer having a plurality of tactile materials during a touch input mode and for changing an arrangement position of the tactile materials according to the applied pattern for distinction of a plurality of input buttons; and
a controller for controlling the pattern apply unit to determine an activation of the input button through tactile sense.

2. The apparatus of claim 1, wherein the layer is coated on the touch screen.

3. The apparatus of claim 1, wherein the pattern apply unit determines the boundary, position, or shape of each input buttons through tactile sense.

4. The apparatus of claim 1, wherein the applied pattern includes at least one of a Korean-alphabet pattern, an English-alphabet pattern, a numeral character pattern, and a braille pattern.

5. The apparatus of claim 1, wherein the pattern apply unit supplies power to the applied pattern so that the tactile materials are arranged to a position around the pattern.

6. The apparatus of claim 5, wherein the pattern apply unit uniformly arranges the tactile materials when power is not supplied to the applied pattern.

7. The apparatus of claim 1, wherein the tactile materials are movable by electric current that flows through the pattern due to the supply of power.

8. A method for providing a touch input of a portable terminal, the method comprising:
applying a predetermined pattern capable to a layer having a plurality of tactile materials during a touch input mode; and
changing an arrangement position of the tactile materials according to the applied pattern.

9. The method of claim 8, wherein the layer is coated on the touch screen.

10. The method of claim 8, wherein the applied pattern is used to determine an activation of the input button through tactile sense.

11. The method of claim 8, wherein the applied pattern is used to determine the boundary, position, or shape of each input buttons through tactile sense.

12. The method of claim 8, wherein the applied pattern includes at least one of a Korean-alphabet pattern, an English-alphabet pattern, a numeral character pattern, and a braille pattern.

13. The method of claim 8, wherein the changing of the arrangement position of the tactile materials according to the applied pattern comprises:
supplying power to the applied pattern to arrange the tactile materials to a position around the pattern.

14. The method of claim 13, further comprising, when power is not supplied to the applied pattern, uniformly arranging the tactile material.

15. The method of claim 8, wherein the tactile materials are movable by electric current that flows through the pattern.

16. A touch screen of a portable terminal, comprising;
a touch screen panel for detecting a touch input;
a layer coated on the touch screen panel and including a plurality of tactile materials;
an input mode determination unit for determining a character input mode operated by a user;
a pattern apply unit for applying a predetermined pattern on the layer; and
a power supply unit for changing arrangement of the tactile materials of the layer by supplying power to the applied pattern on the layer,
wherein the tactile materials are defined according to the applied pattern.

17. The touch screen of claim 16, wherein the input mode includes at least one of a Korean-alphabet pattern, an English-alphabet pattern, a numeral character pattern, and a braille pattern.

18. The touch screen of claim 16, wherein the applied pattern is used to determine an activation of the input button through tactile sense.

19. The touch screen of claim 16, wherein the applied pattern is used to determine the boundary, position, or shape of each input buttons through tactile sense.
